(19) United States
(12) Patent Application Publication
(10) Pub. No.: US 2006/0152068 A1
(43) Pub. Date: Jul. 13, 2006

(54) Motor vehicle accessory

(75) Inventor: Richard Steven Lock, Hants (GB)

Correspondence Address: LOWE HAUPTMAN BERNER, LLP, 1700 DIAGONAL ROAD, SUITE 300, ALEXANDRIA, VA, 22314, US

(73) Assignee: Richard Steven Lock ADCAP Media Ltd., Borehamwood, Hants (GB)

(21) Appl. No.: 10/520,668

(22) PCT Filed: Jul. 9, 2003
(86) PCT No.: PCT/GB03/02966

§ 371 Date: Sep. 19, 2005

(30) Foreign Application Priority Data
Jul. 9, 2002 (GB) 0215785.7

(51) Int. Cl. B60B 7/04

(52) U.S. Cl. 301/37.25

(57) ABSTRACT

A hub cap assembly comprises a hub cap unit mounted rotatably on a fixing unit by a stub axle, which engages a bearing unit, in the fixing unit. A weight is attached off center on the hub cap unit, so the hub cap unit does not rotate with the vehicle wheel. The fixing unit includes a mount having one or more cranked prongs with holes at their ends. The fixing unit is attached to the vehicle wheel by unscrewing the wheel nuts, placing the fixing unit over the wheel bolts, and replacing the wheel nuts. The hub cap unit comprises inner and outer shells with a design between them, the outer shell being transparent.

The present invention relates to motor vehicle accessories, and more specifically to hub caps.

A car wheel is normally fixed to a disc on the end of a shaft by means of bolts; typically there are 5 bolts. In some designs, the bolts are left visible; in such designs, the portions of the wheel around the bolts are often shaped into a heavily moulded appearance. In many designs, however, the bolts are covered by a hub cap which clips onto the wheel. The hub cap is roughly disc shaped, and is usually formed with a distinctive pattern. The hub caps will of course rotate with the wheel.

The object of the present invention is to provide a hub cap with a novel appearance.

According to the main aspect of the invention there is provided a hub cap assembly comprising a fixing attachable to a wheel and a cap unit rotatably mounted on the fixing and weighted to maintain its orientation relative to the ground despite rotation of the wheel, characterized in that the fixing includes a mount having its centre aligned with the wheel axle and at least one aperture radially spaced from the wheel nut for placement on a wheel bolt and retention thereon by the associated wheel nut. Preferably the fixing comprises a plurality of radial spokes each with a corresponding aperture. Optionally some of the apertures may be replaced by forks. The number of spokes may be less than the number of wheel bolts.

The invention also provides a method of attaching a hub cap assembly to a wheel, the hub cap assembly including a fixing attachable to the wheel and a weighted rotatable cap unit, characterized in that the fixing is bolted to the wheel using the wheel nuts and bolts.

The invention also provides a hub cap assembly including a fixing attachable to a wheel and a weighted rotatable cap unit, characterized in that the cap unit comprises an inner shell and an outer transparent shell attached to the inner shell.

With conventional hub caps, the pattern normally has high rotational symmetry. The pattern is effectively not visible when the car is moving at significant speed; when the car is stooped, the pattern may have any orientation. Since the present hub cap assembly, in contrast, maintains its orientation relative to the ground, any pattern on it will always have the same orientation. The pattern can therefore be for example pictorial, and/or can incorporate wording. One potential application of the present hub cap assembly is for advertising purposes.

The discussion above has been primarily in terms of cars, since hub caps are used on cars to a much larger extent than on for example commercial vehicles. However, the present hub cap assembly can be used equally well on commercial vehicles and other motor vehicles.

A hub cap assembly and various modifications thereof, all embodying the invention, will now be described by way of example and with reference to the drawings, in which:

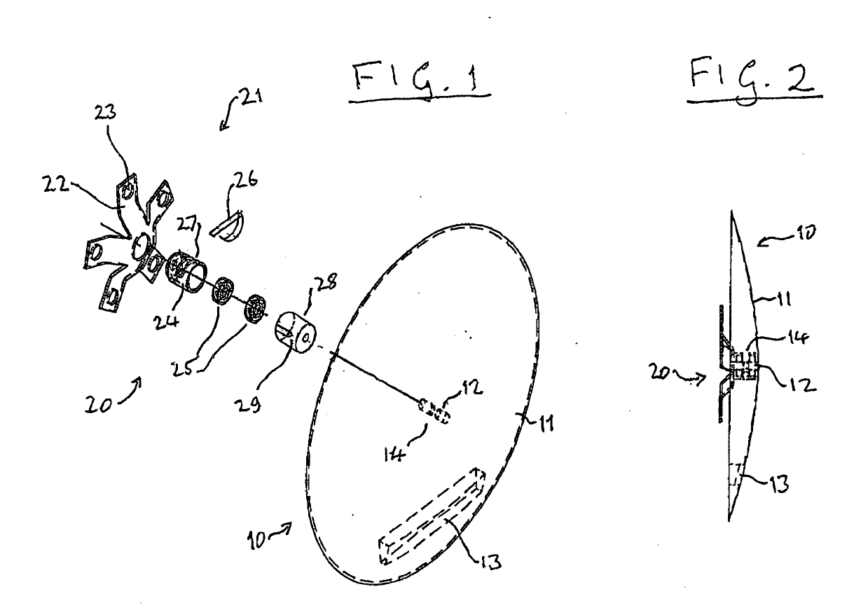

FIG. 1 is an exploded perspective view of the hub cap assembly;

FIG. 2 is a side view of the hub cap unit of the assembly;

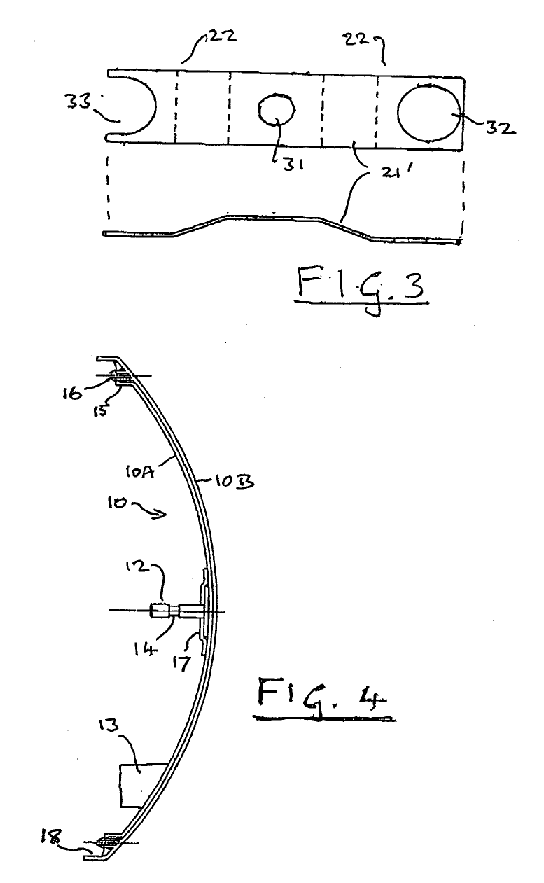

FIG. 3 shows a modified mount for the fixing unit of the assembly, in plan and elevation; and

FIG. 4 shows a modified hub cap unit.

The hub cap assembly comprises a hub cap unit 10 and a fixing unit 20.

The hub cap unit 10 comprises a hub cap element 11 which is slightly dished, as shown in FIG. 2. A stub axle 12 with a grove 14 is mounted at its centre and a weight 13 is attached to it as shown.

The fixing unit 20 comprises a mount 21 with a bearing housing 24 attached to it, a pair of bearings 25 mounted inside the housing 24, and a retaining clip 26. The housing 24 has a slot 27 into which the retaining clip 26 fits. There is preferably also a housing cover 23 which fits over the housing 24; this may have a slot 29 to accommodate the left-hand end of the straight portion of the clip 26. The mount 21 has 5 prongs or spokes 22, each with a respective hole 23 at its end. These prongs are cranked so as to hold the housing 24 above the level of the ends of the prongs and thereby provide clearance for the end of the wheel axle. The mount is dimensioned to fit on the bolts of a standard wheel disc.

To fix the fixing unit 20, the wheel nuts of the wheel are removed, the mount 21 is placed against the wheel and on the wheel bolts, and the wheel nuts refitted. The hub cap unit 10 can then be fitted to the fixing unit by pressing the stub axle 12 into the bearings 25 in the housing 24. The clip 26 engages with the groove 14 in the stub axle and retains the hub cap unit in engagement with the fixing unit.

The hub cap unit can rotate freely on the stub axle in the bearing housing. The weight 13 will move to the lowest point, so maintaining the orientation of the hub cap unit as shown. Any pattern printed or attached to the hub cap unit element 11 will therefore retain the same orientation regardless of the angular position of the wheel.

The mount 21 has to match the design of the wheel to which it is to be fixed. A range of mounts for different vehicle manufacturers may therefore be provided. The mount may have one or more prongs omitted; 3 prongs are clearly sufficient for adequate mounting. Slits may be used instead of the holes 23, to allow for bolts at different radii from the wheel axle for different manufacturers. FIG. 3 shows a modified mount 21′ for use with wheels having an even number of wheel nuts; this mount has a central hole 31 to which the housing 24 is fixed, a bole 32 at one end, and a fork 33 at the other end; the hole 32 and the fork 33 engage with the wheel bolts. Obviously other means, eg clip means engaging with radial elements of the wheel or wheel mounting, may be used instead.

FIG. 4 shows a modified hub cap unit 10′, which comprises an inner shell 10A and an outer shell 10B. The inner shell has the stub axle 12, with its groove 14, fixed to it via a fixing plate 17, and has the weight 13 fixed to it. The inner shell also has a ring of tubular fixing point 15 near its periphery. The outer shell 10B has a corresponding ring of fixing pins 16, with prongs on their ends, to attach it firmly to the inner shell 10A, and also has a protective rim 18 as shown. The design can be painted or otherwise formed on the inner shell 10A, or can be a separate sheet of material which is held between the inner and outer shells. The outer shell is made of transparent material, and protects the design.

The engagement of the hub cap unit 10 and the fixing unit 20 may be made releasable under a strong pull on the hub cap unit, to allow access to the wheel for tyre pressure checking and wheel changing. Alternatively, the hub cap element may be made with apertures allowing access to the inner parts of the wheel and with a cover plate which clips removably over it.

In summary, the invention provides, in its preferred forms, a hub cap assembly comprises a hub cap unit 10 mounted rotatably on a fixing unit 20 by a stub axle 12 which engages in a bearing unit 24, 25, 26, 27 in the fixing unit. A weight 13 is attached off centre on the hub cap unit, so that that unit does not rotate with the vehicle wheel. The fixing unit includes a mount 21 has one or more cranked prongs 22 with holes 23 at their ends, it is attached to the vehicle wheel by unscrewing the wheel nuts, placing the fixing unit over the wheel bolts. and replacing the wheel nuts. The hub cap unit may comprise a pair of shells with a design between them, the outer shell being transparent.

1. A hub cap assembly comprising a fixing attachable to a wheel and a cap unit rotatably mounted on the fixing and weighted to maintain its orientation relative to the ground despite rotation of the wheel, the fixing including a mount having its centre aligned with the wheel axle and at least one aperture radially spaced from the wheel axle for placement on a wheel bolt and retention thereon by the associated wheel nut.

2. A hub cap assembly according to claim 1, wherein the fixing comprises a plurality of radial spokes each with a corresponding aperture.

3. A hub cap assembly according to claim 2, wherein some of the apertures are replaced by forks.

4. A hub cap assembly according to claim 3, wherein the number of spokes is less than the number of wheel bolts.

5. A hub cap assembly according to claim 1, wherein the cap unit and fixing are coupled together by a stub shaft passing into a bearing assembly including a clip for retaining the stub shaft in the bearing assembly.

6. A method of attaching a hub cap assembly to a wheel, the hub cap assembly including a fixing attachable to the wheel and a weighted rotatable cap unit, the method comprising bolting the fixing to the wheel by using the wheel nuts and bolts.

7. A hub cap assembly including a fixing attachable to a wheel and a weighted rotatable cap unit, the cap unit comprising an inner shell and an outer transparent shell attached to the inner shell.

8. (canceled)

9. A hub cap assembly according to claim 7, further including a design between the shells, the design being positioned to be visible to a viewer through the transparent outer shell.

10. A hub cap assembly according to claim 2, wherein the number of spokes is less than the number of wheel bolts.

11. A hub cap assembly according to claim 4, wherein the cap unit and fixing are coupled together by a stub shaft passing into a bearing assembly including a clip for retaining the stub shaft in the bearing assembly.

12. A hub cap assembly according to claim 3, wherein the cap unit and fixing are coupled together by a stub shaft passing into a bearing assembly including a clip for retaining the stub shaft in the bearing assembly.

13. A hub cap assembly according to claim 2, wherein the cap unit and fixing are coupled together by a stub shaft passing into a bearing assembly including a clip for retaining the stub shaft in the bearing assembly.
